(19) United States
(12) Patent Application Publication
(10) Pub. No.: US 2003/0095803 A1
(43) Pub. Date: May 22, 2003

(54) Optical spatial switch

(76) Inventors: Akihiro Iino, Chiba-shi (JP); Masao Kasuga, Chiba-shi (JP); Kenji Suzuki, Chiba-shi (JP); Tomohiro Shimada, Chiba-shi (JP); Fumikazu Oohira, Takamatsu-shi (JP); Yutaka Mihara, Takamatsu-shi (JP); Gen Haraguchi, Takamatsu-shi (JP); Ichirou Ishimaru, Kita-gun (JP)

Correspondence Address: ADAMS & WILKS, 31st Floor, 50 Broadway, New York, NY, 10004, US

(21) Appl. No.: 10/280,813

(22) Filed: Oct. 25, 2002

(30) Foreign Application Priority Data
Nov. 6, 2001 (JP) 2001-341089
Feb. 28, 2002 (JP) 2002-053388

(51) Int. Cl. H04B 10/10; H04B 10/20

(52) U.S. Cl. 398/55

(57) ABSTRACT

The optical spatial switch of the present invention is has a small size and a large capacity to switch optical signals between a plurality of optical fibers in the field of optical communications. The optical spatial switch is composed of: (a) a first optical fiber array having a plurality of optical fibers connected to rear surface of a substrate, and a plurality of output lenses arranged on a surface of the substrate in two-dimensional matrix, in which optical signals input from the plurality of optical fibers are outputted from the plurality of output lenses; and the output lenses provided with control unit output the input optical signals in a predetermined direction, and (b) a second optical fiber array having a plurality of optical fibers connected to rear surface of a substrate and a plurality of light-receiving lenses arranged on a surface of the substrate in two-dimensional matrix to converge optical signals received, in which each optical signal (A1(i, j)) of a plurality of optical signals output from the output lens is received at a predetermined position (A2(k, l)); and the light-recieving lenses provided with control unit transfer resulting optical signals to the optical fibers.

### BACKGROUND OF THE INVENTION

1. Field of the Invention

The present invention relates to an optical spatial switch for switching optical signals between a plurality of optical fibers in the field of optical communications.

2. Description of the Related Art

Conventional switches for the optical communications are of relatively simple configuration and small size to disperse one optical path into two dispersions or two optical paths into two dispersions. However, drastic development of the optical communications necessitates a spatial connecting type optical switch having a large scale and a large capacity capable of transferring paths of optical signals freely between a large number of input optical fibers and a large number of output optical fibers. According to this requirement, large-sized optical switches have been developed. As one example thereof, an optical spatial switch for switching optical signals between arrays of two-dimensional optical fiber is disclosed in JP 05-107485 A.

With this official gazette, as shown in FIG. 10, the optical spatial switch has a configuration in which array A and array B are disposed oppositely and optical fibers 103 and reflecting mirrors 108 are two-dimensionally disposed on the array A and the array B, respectively; optical signal output from lens 104 of the array A is reflected by mirror Mb(i), this reflected light is reflected by mirror Ma(j) of the array A; and ultimately, resulting optical signal is made incident upon light receiving fiber Fb(j) of the array B. However, since such optical spatial switch has a configuration that fibers and mirrors are disposed on the same substrate, there is the problem that it is not possible to reduce the size thereof.

In addition, in the above-described official gazette, there is disclosed, as the related art, an optical spatial switch having a configuration in which two arrays with optical fibers arranged two-dimensionally are placed oppositely, while arranging a plurality of beam shifters therebetween; in which optical signals output from one fiber are shifted successively, then the shifted optical signals are made incident upon given light-receiving lens. However, problems arise in that many beam shifters are disposed at midposition, whereby not only loss of light increases between fibers, but also high accuracy is required for mutual position matching between the two-dimensional fiber arrays 1 and the beam shifters 2.

### SUMMARY OF THE INVENTION

The present invention provides an optical spatial switch that cancels out the above-described problems in such a way as to provide a small-sized spatial switch capable of transferring many incident lights toward output side while establishing connections between input and output optical fiber arrays arbitrarily.

According to a first aspect of the present invention, there is provided an optical spatial switch including following members:

(a) an optical fiber array which outputs optical signals input from a plurality of optical fibers connected to rear surface of a substrate from a plurality of output lenses arranged on a surface of the substrate in two-dimensional matrix, in which the output lenses provided with control means converts the input optical signals into converging rays, parallel rays, or diverging rays, before outputting these rays in a predetermined direction, and

(b) a second optical fiber array that receives each optical signal (A1(i, j)) of a plurality of optical signals output from the output lens at a-predetermined position (A2(k, l)) thereof, in which light-receiving lenses are disposed on a surface of a substrate of the second optical fiber array with the light-receiving lenses arranged in two-dimensional matrix; the light-receiving lenses converge optical signals received; and the light-receiving lenses provided with control means transfer resulting optical signals toward optical fiber connected to rear surface of the substrate.

According to a second aspect of the present invention, there is provided an optical spatial switch characterized in that the output lens and the light-receiving lens are both spherical lenses.

According to a third aspect of the present invention, there is provided an optical spatial switch characterized in that the control means of the output lens and the light-receiving lens is respectively an actuator for controlling rotation of the spherical lens.

According to a fourth aspect of the present invention, there is provided an optical spatial switch characterized in that the control means of the output lens and the light-receiving lens is respectively an actuator for operating the lens in a direction perpendicular to a direction of output light output from the optical fiber.

According to a fifth aspect of the present invention, there is provided an optical spatial switch including following members:

(a) an optical fiber array provided with a plurality of output lenses arranged on a surface of a substrate in two-dimensional matrix, in which the optical fiber array outputs optical signals input from a plurality of optical fibers connected to rear surface of the substrate from the plurality of output lenses; the optical fiber array is provided with collimate lenses next to the optical fibers; and the output lenses provided with control means converts the input optical signals into converging rays, parallel rays, or diverging rays, before outputting these rays in a predetermined direction, and

(b) a second optical fiber array that receives each optical signal (A1(i, j)) of a plurality of optical signals output from the output lens at a predetermined position (A2(k, l)) thereof, in which light-receiving lenses are disposed on a surface of a substrate of the second optical fiber array with the light-receiving lenses arranged in two-dimensional matrix; the light-receiving lenses converge optical signals received; and the light-receiving lenses provided with control means transfers resulting optical signals toward optical fiber connected to rear surface of the substrate.

According to a sixth aspect of the present invention, there is provided an optical spatial switch characterized in that the second optical fiber array further includes a converging lens at mid-position between the light-receiving lens and the optical fiber.

According to a seventh aspect of the present invention, there is provided an optical spatial switch characterized in that the output lens and the light-receiving lens are respectively a spherical lens.

According to an eighth aspect of the present invention, there is provided an optical spatial switch characterized in that the control means of the output lens and the light-receiving lens is respectively an actuator for controlling rotation of the spherical lens.

According to a ninth aspect of the present invention, there is provided an optical spatial switch characterized in that the control means of the output lens and the light-receiving lens is respectively an actuator for operating the lens in a direction perpendicular to a direction of output light output from the optical fiber.

According to a tenth aspect of the present invention, there is provided an optical spatial switch including following members:

(a) an optical fiber array which outputs optical signals input from a plurality of optical fibers connected to rear surface of a substrate from a plurality of output lenses arranged on a surface of the substrate in two-dimensional matrix, in which the output lenses provided with control means converts the input optical signals into converging rays, parallel rays, or diverging rays, before outputting these rays in a predetermined direction,

(b) a second optical fiber array that receives each optical signal (A1(i, j)) of a-plurality of optical signals output from the output lens at a predetermined position (A2(k, l)) thereof, in which light-receiving lenses are disposed on a surface of a substrate of the second optical fiber array with the light-receiving lenses arranged in two-dimensional matrix; the light-receiving lenses converge optical signals received; and the light-receiving lenses provided with control means transfer resulting optical signals toward optical fibers connected to rear surface of the substrate, and

(c) at least one reflecting means which is provided with control means, arranged spatially at mid-position between the first optical fiber array and the second optical fiber array, in which optical signals output from respective output lenses of the first optical fiber array are reflected toward the light-receiving lenses of the second optical fiber array.

According to an eleventh aspect of the present invention, there is provided an optical spatial switch characterized in that the output lens of the first optical fiber array and the light-receiving lens of the second optical fiber array are respectively a spherical lens.

According to a twelfth aspect of the present invention, there is provided an optical spatial switch characterized in that the at least one reflecting means is composed of a first reflecting means and a second reflecting means.

According to a thirteenth aspect of the present invention, there is provided an optical spatial switch characterized in that the first reflecting means and the second reflecting means are mirror reflecting means provided with mirrors controlled by actuators.

According to a fourteenth aspect of the present invention, there is provided an optical spatial switch characterized by including:

a mechanism which is composed of a substrate capable of rotating about one axis, a rotating base plate capable of rotating on the substrate about an axis perpendicular to the axis of rotation of the substrate, and a mirror provided on the rotating base plate.

According to a fifteenth aspect of the present invention, there is provided an optical spatial switch characterized by including:

a mechanism which is composed of a rotatable first substrate, a rotatable second substrate capable of rotating on the first substrate, and a mirror provided on the second substrate.

According to a sixteenth aspect of the present invention, there is provided an optical spatial switch characterized by including:

a mechanism which is composed of a piezoelectric transducer capable of exciting oscillating waves in the two different directions, a movable body that comes into contacts with the piezoelectric transducer, and a mirror provided on the movable body.

According to a seventeenth aspect of the present invention, there is provided an optical spatial switch characterized by including:

a mechanism which is composed of a mirror portion made of at least magnetic material, and a plurality of electromagnets provided at positions that overlap onto the mirror portion in its thickness direction.

According to an eighteenth aspect of the present invention, there is provided an optical spatial-switch including following members:

(a) a first optical fiber array that includes a plurality of optical fibers one point of which is supported, a lens fixed on the optical fiber in the vicinity of one end thereof, and a control means that operates the optical fiber in the direction perpendicular to optical axis of the optical fiber; and

(b) a second optical fiber array that includes a plurality of optical fibers one point of which is supported to receive a plurality of optical signals output from the first optical fiber array at a predetermined position, a lens fixed on the optical fiber in the vicinity of one end thereof, and a control means that operates the optical fiber in the direction perpendicular to optical axis of the optical fiber.

According to a nineteenth aspect of the present invention, there is provided an optical spatial switch characterized by including:

a substrate having an opening portion;

a fiber one point of which is supported, that is in the opening portion; and

a lens fixed on the fiber in the vicinity of one end thereof,

in which the substrates are made to drive individually in the two axes directions of X and Y so that angle of output light from the fiber or light-receiving angle of light made incident upon the fiber is varied.

According to a twentieth aspect of the present invention, there is provided an optical spatial switch characterized by including:

two substrates having opening portions;

a fiber one point of which is supported, that is in the opening portion; and

a lens fixed on the fiber in the vicinity of one end thereof,

in which the two substrates are driven individually in the two axes directions of X and Y so that angle of output light from the fiber or light-receiving angle of light made incident upon the fiber are varied.

According to a twenty-first aspect of the present invention, there is provided an optical spatial switch characterized by including:

an optical fiber one point of which is supported;

a magnetic member fixed on the optical fiber in the vicinity of one end thereof;

a plurality of yokes provided at outer side of the magnetic member; and

coils wound around the plurality of yokes,

in which quantity of current flowing through the respective coils are controlled so that angle of the optical fiber is controlled, and then since the angle of the optical fiber is controlled, angle of output light from the fiber or light-receiving angle of light made incident upon the fiber is varied.

The following are aspects of the invention that are common to the above-mentioned aspects of the present invention.

According to a twenty-second aspect of the present invention, there is provided an optical spatial switch characterized in that the plurality of output lenses of the first optical fiber array and the light-receiving lenses of the second optical fiber array have a disposition of two-dimensional matrix of “integer number I×integer number J,” respectively.

According to a twenty-third aspect of the present invention, there is provided an optical spatial switch characterized in that I and J of the “integer number I×integer number J” are of integer numbers selected individually from 3 to 9.

According to a twenty-fourth aspect of the present invention, there is provided an optical spatial switch characterized in that a plurality of output lenses of the first optical fiber array are arranged in two-dimensional matrix of “integer number I×integer number J”, and light-receiving lenses of the second optical fiber array are two-dimensional matrix of “integer number P×integer number Q”, where relationship of respective dispositions satisfies “I×J≦P×Q”.

According to a twenty-fifth aspect of the present invention, there is provided an optical spatial switch characterized in that a leading edge portion of an optical fiber, which is connected to the first optical fiber array, and the second optical fiber array, is a spherical lens integrated with the optical fiber.

According to a twenty-sixth aspect of the present invention, there is provided an optical spatial switch characterized in that leading edge portions of the first optical fiber array and the second optical fiber array are of multi-mode fibers that are connected to single-mode fibers.

According to a twenty-seventh aspect of the present invention, there is provided an optical spatial switch characterized in that leading edge portions of the first optical fiber array and the second optical fiber array have configurations in which the single-mode fiber is processed into conical shape, spherical shape, or cylindrical shape which is a combination of the conical shape and the spherical shape.

According to a twenty-eighth aspect of the present invention, there is provided an optical spatial switch characterized in that the actuator is a piezoelectric actuator (a ultrasonic actuator) According to a twenty-ninth aspect of the present invention, there is provided an optical spatial switch characterized in that the actuator is an electromagnetic actuator.

According to a thirtieth aspect of the present invention, there is provided a ultrasonic actuator that includes a piezoelectric element, a stator with an opening portion, a pressure plate, and a movable body that is sandwiched between the opening portion of the stator and the pressure plate.

### BRIEF DESCRIPTION OF THE DRAWINGS

In the accompanying drawings:

FIG. 1 is a view showing an embodiment in which optical signal is transferred directly from a first optical fiber array to a second optical fiber array;

FIG. 2 is a view showing a configuration of an optical fiber inside an optical fiber array;

FIG. 3 is a view showing a configuration of a spherical lens utilized in the present invention;

FIG. 4 is a view showing propagation state of light in the spherical lens shown in FIG. 3;

FIG. 5 is a view showing an embodiment in which optical signal is transferred from the first optical fiber array to the second optical fiber array via a reflecting mirror;

FIG. 6 is a view showing various embodiments of mechanisms for rotating the reflecting mirror;

FIG. 7 is a view showing a configuration of a spherical mirror;

FIG. 8 is a view showing an embodiment in which an optical fiber is driven directly;

FIG. 9 is a view showing a configuration of an optical fiber integrated with a lens;

FIG. 10 is a view showing an example of a conventional optical spatial switch;

FIG. 11 is a view showing the principle of an optical switch by lens drive;

FIG. 12 is a view showing another example of the principle of the optical switch by lens drive;

FIG. 13 is a view showing an example of structure that drives the mirror using electromagnetic force;

FIG. 14 is a view showing a method of forming mirrors using photolithography technique; and

FIG. 15 is a view showing a structure for driving an optical fiber using electromagnetic actuator.

### DETAILED DESCRIPTION OF THE PREFERRED EMBODIMENTS

Embodiments of the present invention will be explained below with reference to accompanying drawings, however, the following embodiments represent merely illustration for explaining the present invention specifically. The present invention is not limited thereto and include the whole embodiments capable of being conceived easily by the skilled persons in the art.

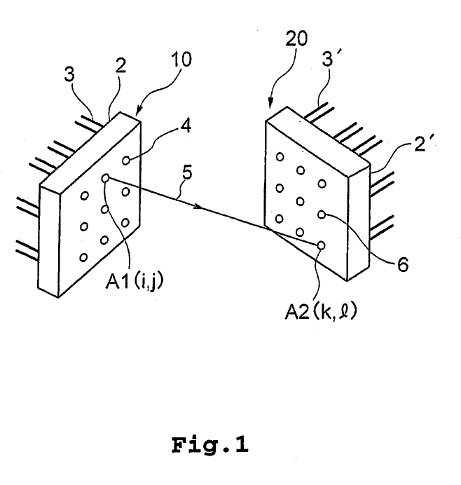

FIG. 1 is a schematic view of an optical spatial switch composed of two pieces of optical fiber arrays 10 and 20. Respective arrays include, for instance, metallic substrates 2, 2′ to which optical fibers 3, 3′ are connected from respective rear sides thereof, and respective output lenses 4 and light-receiving lenses 6 are two-dimensionally disposed on surfaces of the respective substrates that stand opposite to each other. Optical signals 5 of an output side output from lens A1(i, j) arbitrarily are controlled by control means, such as an actuator, so that a direction of output light output from the lens is controlled to emit the optical signals toward a target arbitrary light-receiving lens A2(k, l). This light-receiving lens converges optical signals received to transfer the optical signals to the optical fiber 3 of the rear side.

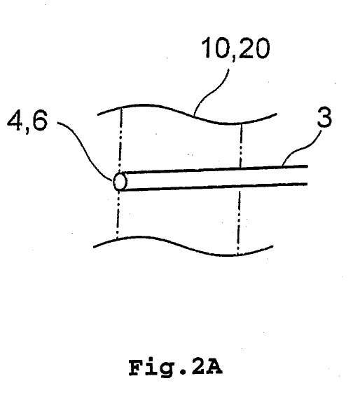

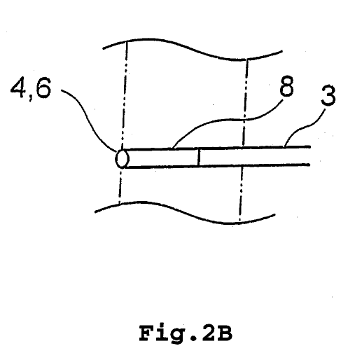

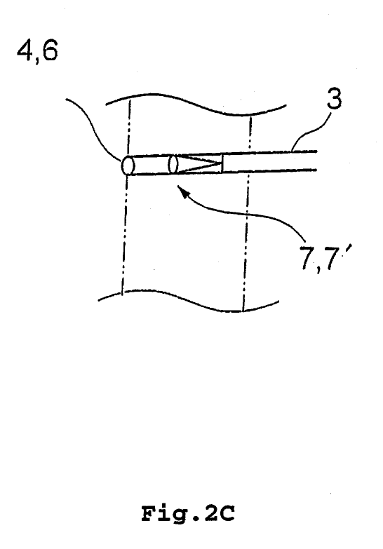

FIG. 2 shows an embodiment of connection between optical fibers 3, 3′ and the output lens 4 or the light-receiving lens 6. FIG. 2A shows an embodiment in which single mode fiber 3 is connected to the output lens 4 or the light-receiving lens 6. In this embodiment, it is assumed that optical signals from the optical fiber are not collimated or converged, therefore optical signals from the optical fiber are converted into converging rays, parallel rays, or diverging rays by the lenses 4, 6.

In an embodiment of FIG. 2B, a multi mode fiber is connected to a leading edge portion of a single mode fiber, thereby optical signals are collimated or converged in this portion. Accordingly, the lenses 4, 6 are enough to provide function to emit optical signals of the output light or the received light in the predetermined direction.

In FIG. 2C, collimate lens 7 or converging lens 7′ is provided at single mode fiber 3. In this case, like the above description, an output lens 4 is enough to emit optical signals in the predetermined direction, and a light-receiving lens 6 is enough to converge optical signals. It should be noted that if leading edge portions of the fibers 3, 3′ are processed into conical shaped lens, spherical shaped lens or cylindrical shaped lens which is a combination of the conical shaped lens and the spherical shaped lens instead of the above-described collimate lens 7 or the converging lens 7′, the leading edge portion each exercises function of lens.

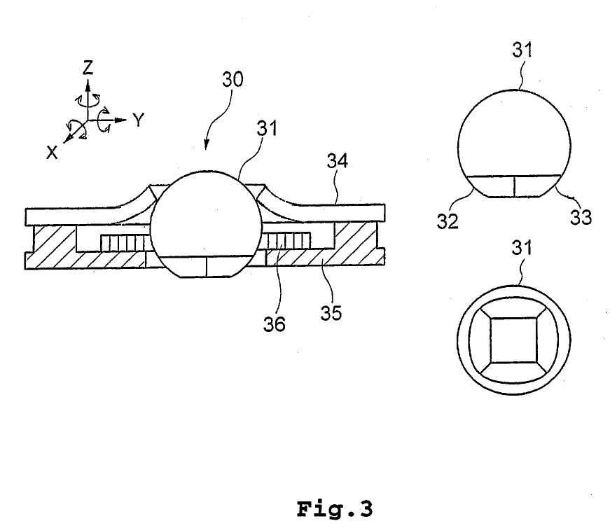

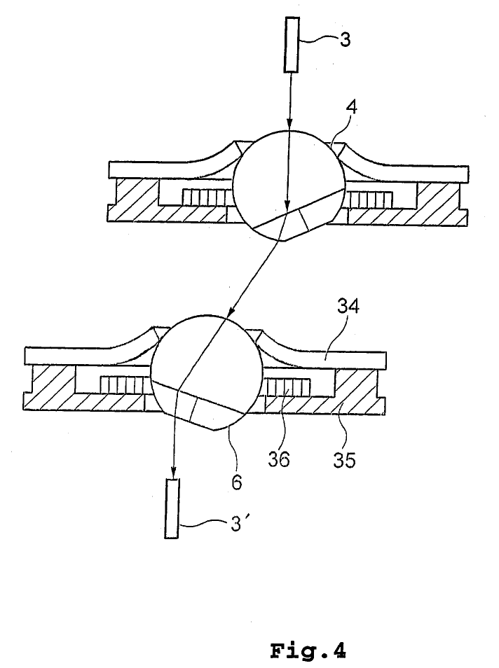

Next, structures of an output lens and a light-receiving lens used in the present invention are explained with reference to FIG. 3 and FIG. 4. As shown in FIG. 3, this lens is of spherical lens 30, and composed of an upper portion 31 that refracts lights made incident from upper side with respect to the drawing toward inside, and a lower portion that outputs lights in the predetermined direction. This lower portion is composed of tetrahedron 32 and underside 33, having function for changing output direction light. Flat surface of the tetrahedron has function by which light from the inside is refracted in the constant direction.

A lens mechanism is shown that controls output light or received light into the predetermined direction, where a lens to be a movable body is rotatably engaged with stator 36 composed of piezoelectric element and accommodated in substrate 35. The lens is pressurized to a stator 36 by a pressure plate 34 from above and accommodated in control means. In this case, the substrate 35, stator 36, and pressure plate 34 constitute actuator, thus constituting ultrasonic motor as the actuator. It should be noted that actuator for controlling lens is not restricted to ultrasonic motor, but also, for instance, electromagnetic actuator composed of coil and iron core is appropriate. Spherical surface of the lens comes into contact with the stator 36, whereby the lens is rotated in the directions of X, Y, and Z of the drawing according to rotation of the stator about the Z-axis, thus it is possible to change direction of output light or incident direction of light.

Next, operation of the above-described spherical lens is explained using FIG. 4. FIG. 4 shows the output lens 4 at upper side in the drawing, and the light-receiving lens 6 at lower side in the drawing. Optical signal made incident upon the lens 4 from optical fiber 3 of upper side is transferred in the direction of arrow. The output lens 4 collimates light made incident thereupon from optical fiber 3, before outputting light in the predetermined direction. The actuator to be control means rotates the lens 4 about, for instance, Z-axis and X-axis to output light in the direction of lens that receives the light. Meanwhile, the light-receiving lens 6 is controlled by the actuator in such a way as to converge received optical signals in the direction of the optical -fiber 3′.

In addition, as system for changing output direction or incident direction of light, following system may be applied.

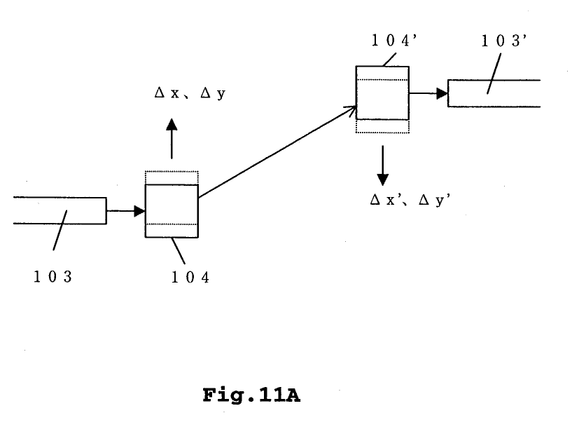

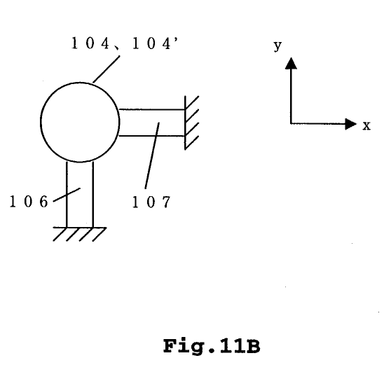

As shown in FIG. 11A and FIG. 11B, output direction of light may be changed in such a way as to move the lens in x-direction and y-direction that are right angles to optical axis. The optical signal made incident upon lens 104 from optical fiber 103 is transferred in the direction of arrow by moving lens 104 only by movement amount of x, y. Lens 104′ is moved only by movement amount of x′, y′ to a position where the light input to the lens 104′ is converged to fiber 103′.

For instance, piezoelectric actuators 106, 107 are connected to the lens 104 in two directions thereof and also connected to the lens 104′ in two directions thereof respectively, thus controlling positions of the lenses 104, 104′ in such a way as to control the piezoelectric actuators 106, 107 independently.

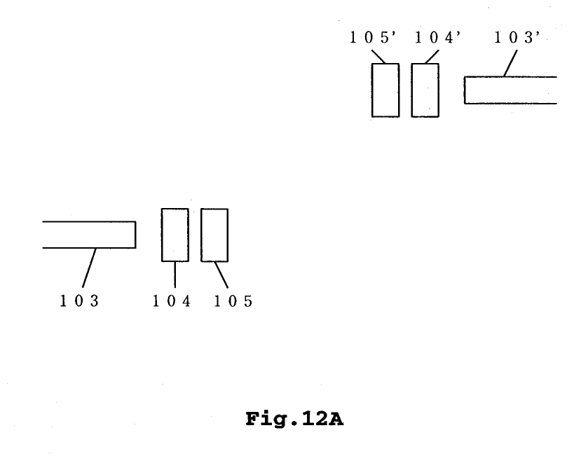

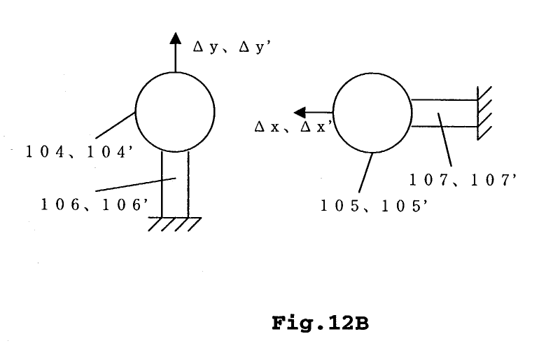

In addition, as shown in FIG. 12A and FIG. 12B, it is possible to provide the lens 104 and the lens 104′ capable of operating only in the direction of x, and the lens 105 and the lens 105′ capable of operating only in the direction of y separately. In this case, movement of actuators 106 and 107 is unaffected mutually, whereby it is possible to secure large operation displacement, resulting in simple control.

The explanation has been made by using piezoelectric actuator as an example. However, it is also appropriate to use electromagnetic type actuator and configurations thereof are not restricted. In addition, shape of lens is not restricted, however, as indicated in description below, lenses differ in characteristics obtained according to type of the lens, whereby lens is selected depending on a target switch or performance of an actuator used therein.

When spherical lens is used, since spherical lens has a small curvature, large (angular) change of optical axis is obtained with respect to small movement of the lens, however, if lengthening movement of light, the lens loses function as collimator. Conversely, when convex lens is used, large (angular) change of optical axis is difficult to be obtained, however, even if lengthening movement of light, the lens is capable of maintaining function as collimator. Further, in the case of non-spherical lens, it possible to obtain long movement of light while maintaining function as collimator. Furthermore, in the case of SELFOC lens, this makes it possible to obtain relatively long movement of light with function as collimator maintained, and large (angular) change of optical axis with respect to relatively small movement of the lens can be obtained.

Although detailed explanation with respect to actuator will be omitted, generally, actuator is means for controlling each optical signal (A1(i, j)) of a plurality of optical signals output from the above described output lens so that light-receiving lens can receive the light at the predetermined position (A2(k, l)). Actuators are of, for instance, piezoelectric actuator or ultrasonic motor to operate the output lens and the light-receiving lens by the predetermined method so that light of arbitrary output lens can reach light-receiving lens specified arbitrarily. Accordingly, transfers of optical signals can be performed arbitrarily between arbitrary output lens and light-receiving lens, thus, optical spatial switch can be realized.

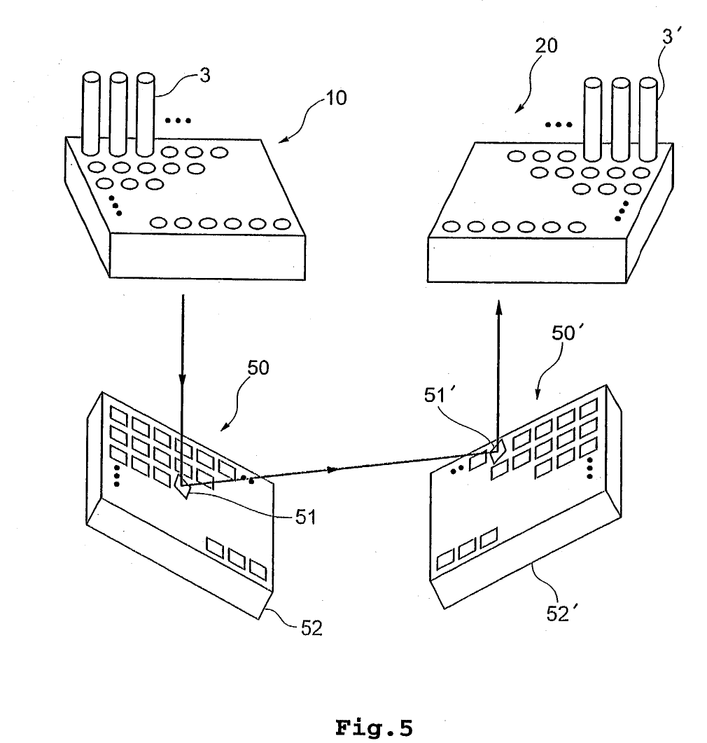

FIG. 5 shows another embodiment of the present invention. In FIG. 5, an example of two light reflecting mirrors is shown, however, even if one light reflecting mirror is used, optical spatial switch can be realized. In this example, optical fiber array 10 of output side and optical fiber array 20 of light-receiving side are disposed spatially; in which optical signal output from the array of the output side is reflected by specific mirror 51 of the first reflecting mirror array 50, subsequently, the reflected optical signal is reflected by mirror 51′ of the second reflecting mirror array to reach the second optical fiber array 50′ of the light-receiving side.

Structure of optical fiber of the output side and the light receiving side is the same as that described above. Respective reflecting mirror arrays are two-dimensionally disposed on surfaces of substrates 52 and 52′, although there is accompanied by no restriction, it is favorable that two-dimensional disposition thereof and two-dimensional disposition of the output array and the light receiving array become similar figure with each other. Respective mirrors are capable of varying in their respective angles by using actuator. Ultrasonic motor described-above is capable of being utilized preferably as an actuator.

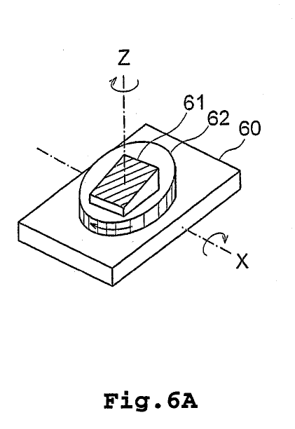

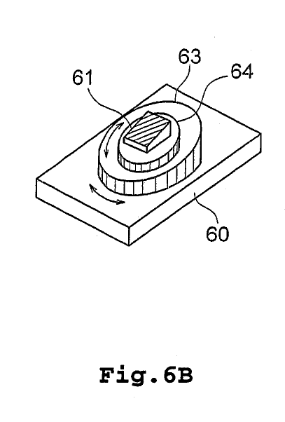

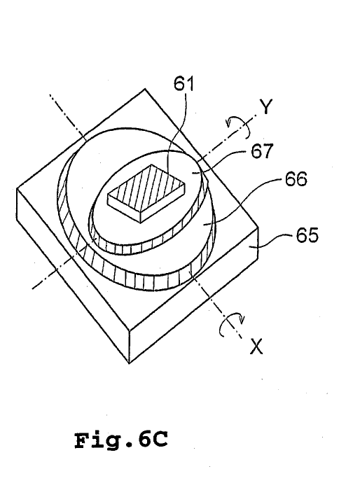

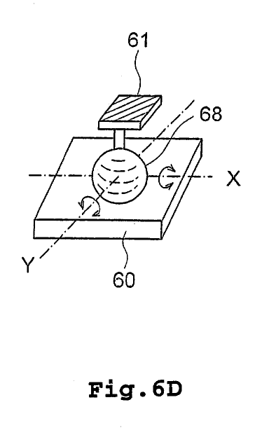

FIG. 6A to FIG. 6D show mechanisms for changing angles of the reflecting mirrors. A mechanism shown in FIG. 6A includes slant rotating base plate 62 that rotates on substrate 60 and slant mirror 61 fixed on the slant rotating base plate 62. As shown in FIG. 6A, the substrate 60 rotates about X-axis, and the slant rotating base plate 62 rotates about Z-axis, thus it is possible to face the mirror toward arbitrary direction.

A mechanism shown in FIG. 6B includes two substrates 63 and 64 which rotate independently one relative to the other on fixed substrate 60 and a mirror fixed on the substrate 63, thus it is possible to face the mirror toward arbitrary direction due to rotations of the substrates 63 and 64.

A mechanism shown in FIG. 6C includes rotating base plate 66 engaged with frame body 65 with the rotating base plate 66 rotated freely about X-axis of the frame body 65, rotating base plate 67 engaged with the rotating base plate 66 with the rotating base plate 67 rotated freely about Y-axis of the frame body 65, and mirror 61 fixed on the rotating base plate 67, thus it is possible to face the mirror toward arbitrary direction due to operation of the members.

A mechanism shown in FIG. 6D comprises substrate 60 that is piezoelectric transducer and so forth capable of exciting oscillation wave of, for example, surface wave and so forth in two directions of X-axis direction and Y-axis direction, spherical body 68 that rotates about the X-axis and the Y-axis, and mirror 61 fixed on the spherical body 68, where the spherical body 68 to be a movable body rotates within frame body (not illustrated). Consequently, the mirror 61 is capable of being faced toward arbitrary direction.

Although detailed explanation with respect to rotation of the rotating base plate and the spherical body will be omitted, generally, the above described rotating base plate and spherical body rotate while being controlled by powerful small sized motor, such as, ultrasonic motor and so forth, where direction of mirror is controlled accurately to exercise function of optical spatial switch between the first optical fiber array and the second optical fiber array.

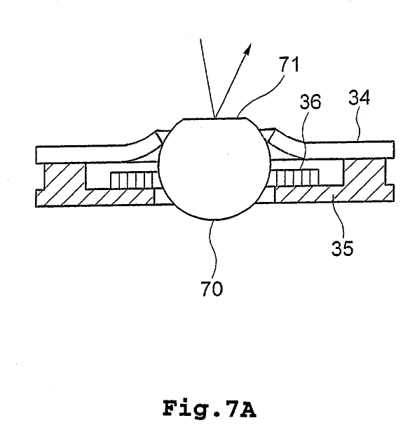

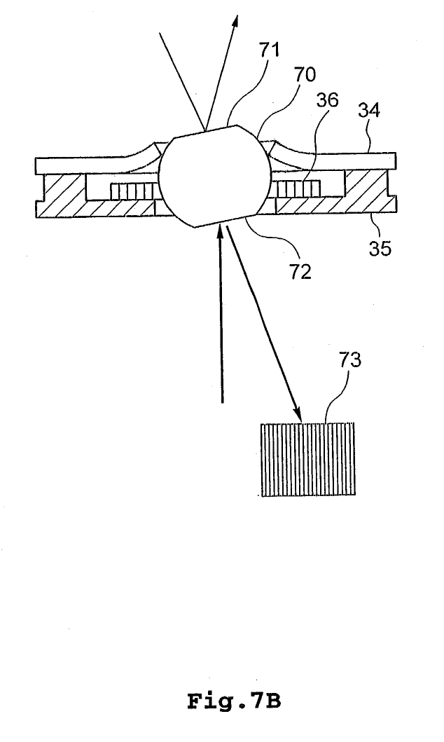

In FIG. 6, mirror is changed in its direction by using general 2-axis rotating system, however, in FIG. 7, another new means for changing direction of mirror is explained. FIG. 7A shows spherical reflecting mirror provided with smooth reflecting surface 71 formed in such a way as to cut a part of spherical glass 70. And then, the spherical glass 70 to be movable body rotates, for example, after undergoing friction drive by oscillation of stator 36 driven by piezoelectric element, to face the reflecting surface 71 toward predetermined direction. Consequently, as shown in the drawing, light directed to the reflecting surface is reflected toward the predetermined direction in accordance with rotation of the spherical glass.

FIG. 7B shows spherical reflecting mirror provided with smooth reflecting surface 71 and smooth reflecting surface 72 formed parallel to the reflecting surface 71. Optical signal for controlling is made incident upon this reflecting surface 72 before the reflected light is received by light-receiving sensor, such as, for instance, CCD to measure position of the reflected light, thus, it is possible to measure angle and direction of the spherical reflecting mirror. In this way, angle and direction of the spherical reflecting mirror are measured and of necessary, angle and direction of the reflecting mirror are adjusted by the stator 36, whereby incident light can be made incident upon the second optical fiber array located at the predetermined position.

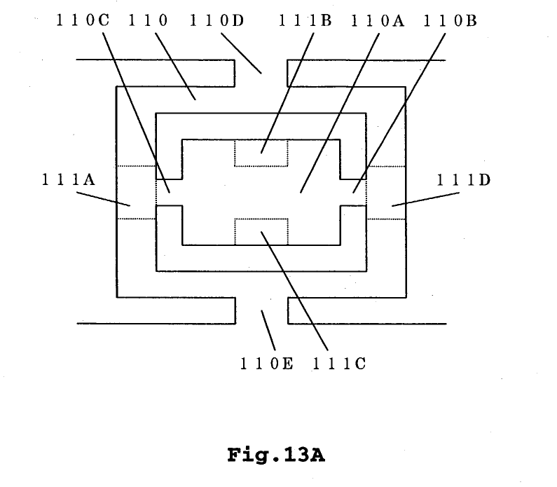

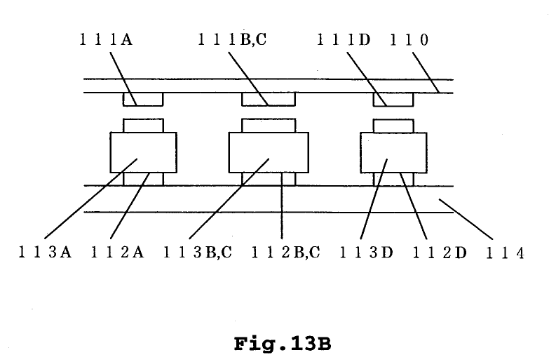

FIG. 13A and FIG. 13B show an example in which mirror is operated by electromagnetic force. Mirror drive portion 110 is constituted integrally with mirror 110A, and hinge portions 110B, 110C, 110D, and 110E. Magnetic material films (111A, 111B, 111C, and 111D) such as permalloy and so forth are joined at four places on one surface of the mirror drive portion 110. There are provided yokes 112A, 112B, 112C, and 112D around of which coils 113A, 113B, 113C, and 113D are wound, with gap between the coils and the magnetic material films. When-current quantity for the respective coils is-controlled, attraction force between the respective yokes and the magnetic material films is changed, thus, angle of the mirror 110A is capable of being changed arbitrarily. It should be noted that it is to provide the magnetic material film wholly at the mirror drive portion 110. In addition, it is also possible to form the magnetic material films are by method of vacuum evaporation or sputtering or so forth.

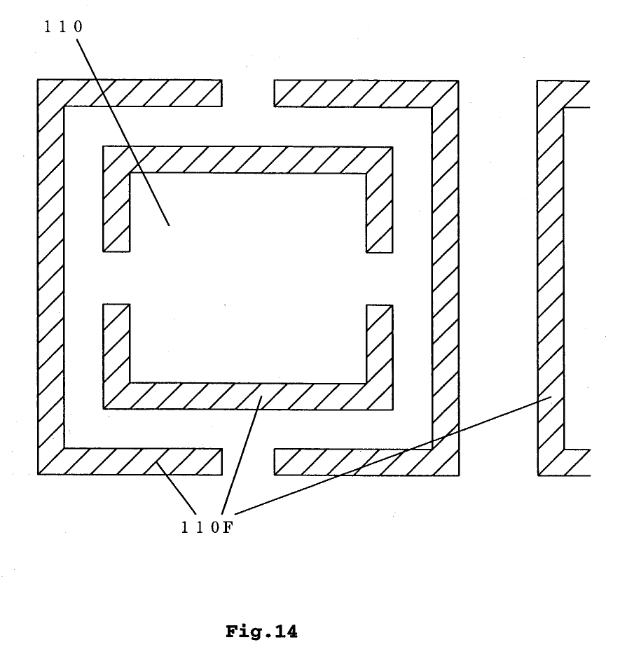

It is possible to form a plurality of matrix shape magnetic material films in the whole mirror drive portion by one time processing using photolithography technique and so forth. Specifically, this becomes possible due to formation of the magnetic material films by removing diagonal line portions of FIG. 14 using etching method.

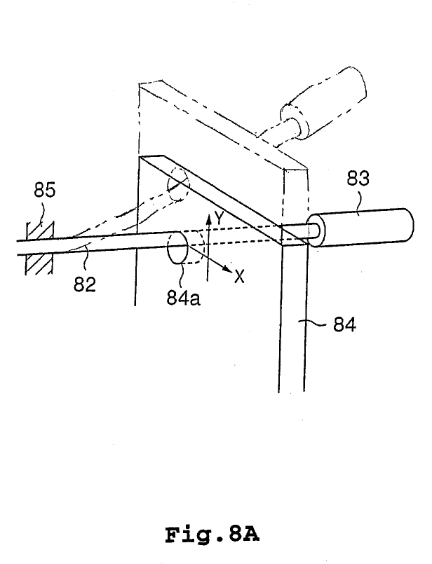

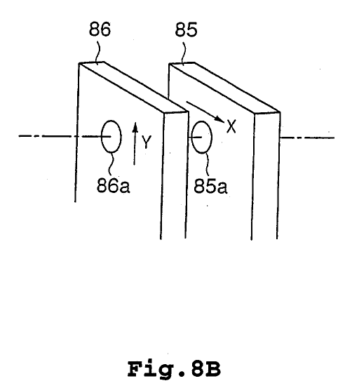

FIG. 8 shows still another embodiment of the present invention.

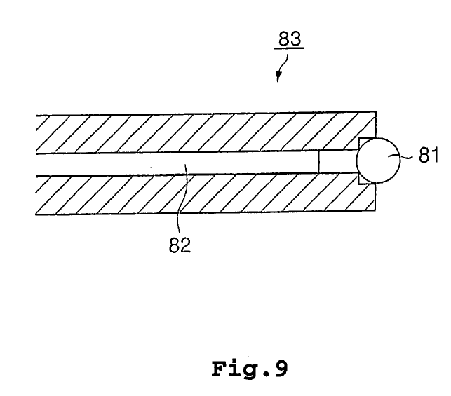

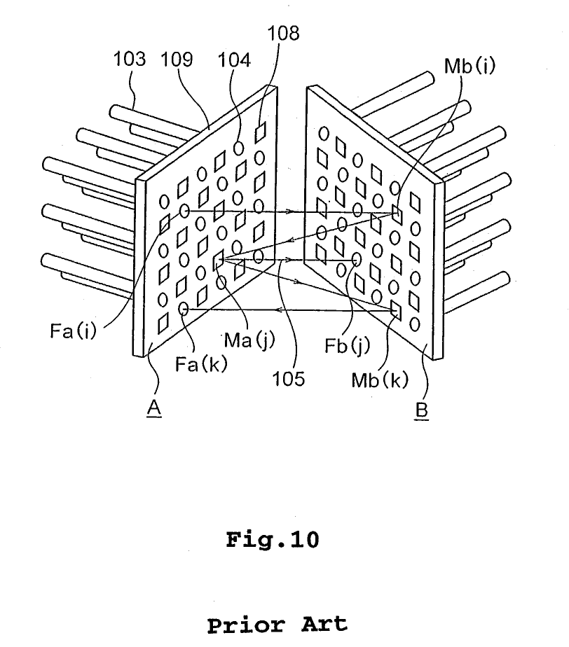

In the above description, the example in which rotation of the output lens and the light-receiving lens is controlled is shown. The present example shows that, as shown in FIG. 9, direction of collimator 83 itself formed in such a way as to integrate lens 81 with fiber 82 is intended to be controlled directly.

In FIG. 8A, when substrate 84 with opening portion 84a is moved in two axes directions of X and Y, leading edge (collimator 83) of fiber 82, being in the opening portion 84a, and one point thereof being supported by supporting portion 85, moves in two axes directions of X and Y.

In FIG. 8B, there are provided two substrates 85 and 86 with opening portions, 85a and 86a, if the substrates A and B are moved individually in two axes directions of X and Y, leading edge (collimator 83) of fiber 82 operates in two axes directions of X and Y.

The substrates 84, 85, and 86 are operates by, for example, linear type ultrasonic motor. Oscillating body having piezoelectric element (not shown) is made to come into contact with the substrates 84, 85, and 86 directly with the oscillating body pressurized on the substrates 84, 85, and 86, whereby linear type ultrasonic motor with the substrates 84, 85 and 86 as movable bodies is constituted.

In addition, it is possible to drive the substrates 84, 85, and 86 by electromagnetic type actuator such as voice coil type actuator and so forth.

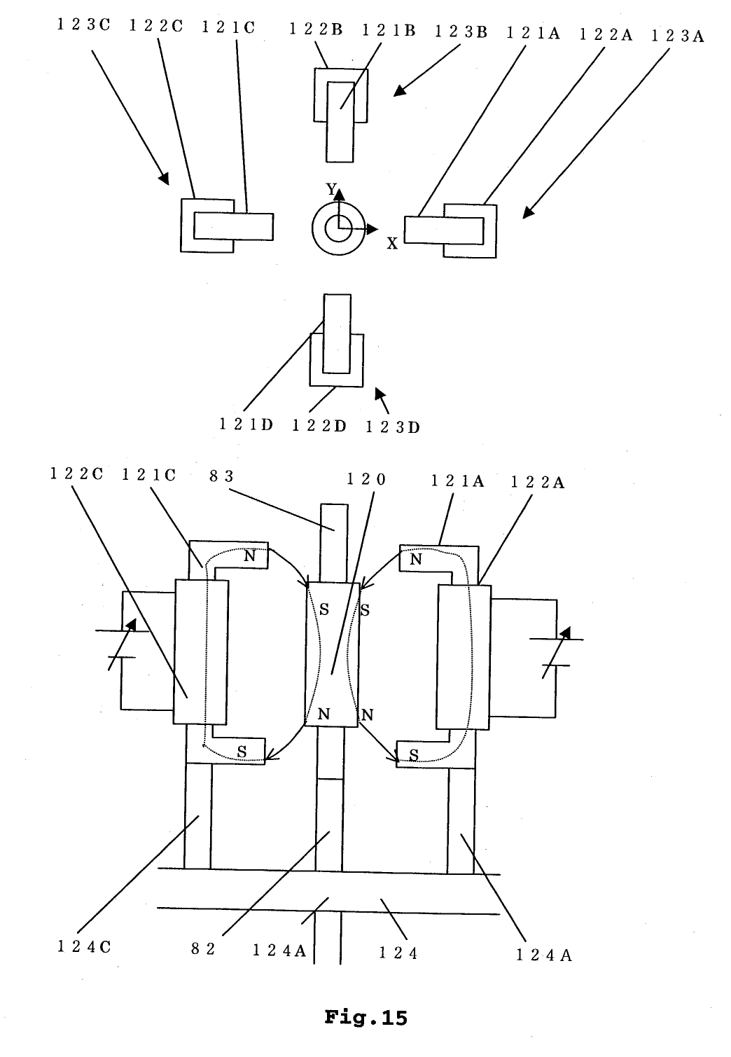

FIG. 15 shows an example in which electromagnetic type actuator is used. One point of fiber 82 provided with collimator 83 at its leading edge is supported by supporting point 124A of supporting member 124. In addition, magnetic member 120 such as permalloy and so forth is provided at periphery portion of the collimator 83. Yokes 121A, 121B, 121C and 121D around of which coils 122A, 122B, 122C and 122D are wound are provided around the magnetic member 120. When current flows in coils 122A, 122B, 122C, and 122D, yoke 121A, 121B, 121C, or 121D and magnetic pipe 120 form magnetic path respectively, and line of magnetic force generated from one end N-pole of yoke 121A, 121B, 121C, or 121D is passed through the magnetic pipe 120, thus the magnetic pipe 120 is attracted toward yoke side. When varying current flowing through each coil 122A, 122B, 122C or 122D, attraction force of each coil 122A, 122B, 122C, or 122D to the magnetic member 120 with the collimator 83 provided varies. Through being subjected to attraction force of each stator-yoke 121A, 121B, 121C, or 121D it is possible to vary angle of collimator 83 arbitrarily.

The number of coils and yokes are selected arbitrarily. In addition, when there is provided magnet instead of the magnetic member 120, large displacement can be obtained with small current.

Still another embodiment of the present invention is described below. In this embodiment, a plurality of output lenses of the first optical fiber array and a plurality of light-receiving lenses of the second optical fiber array are arranged in two-dimensional matrix of integer number I×integer number J. It is possible to select the numbers for I and J from, for example, 4 to 256, further up to around 400 at the maximum. It should be noted that the whole number of mirrors of optical fiber array can be selected from the numbers up to 400 at the maximum, however, in order to cope with the case that a part thereof is broken down, and so forth, it is possible to select a configuration in which one unit block is provided with the number of mirrors of (4 to 8)×(4 to 8). When a part of the mirrors is broken down, rapid repair becomes possible in such a way as to exchange mirror in every one block.

According to still another embodiment, it may be preferable that a plurality of output lenses of the first optical fiber array are arranged in two-dimensional matrix of “integer number I×integer number J”, and light-receiving lenses of the second optical fiber are arranged in two-dimensional matrix of “integer number P×integer number Q”, where relationship of respective dispositions satisfies “I×J≦P×Q”. Therefore, optical fiber array of light-receiving side is provided with extra light-receiving lenses, thereby enabling connection to a new path.

Further, according to another embodiment, as already described above, it is possible that the leading edge portion of the optical fiber, which is connected to the first optical fiber array, and the second optical fiber array, is a spherical lens integrated with the optical fiber.

According to still another embodiment, it is possible that the leading edge portions of the first optical fiber array and the second optical fiber array are of multi-mode fibers that are connected to single-mode fibers. This is because the multi-mode fibers function as collimators or light-receiving lenses, whereby conventional collimate lenses or light-receiving lenses become unnecessary.

As described-above, in the present invention, piezoelectric actuators are capable of being utilized as the above described actuators. Piezoelectric actuator has high response whereby high speed switching operation becomes possible. In particular, ultrasonic motor is of small size and high torque, and can hold movable body without power consumption, whereby the ultrasonic motor may preferably be used as actuators in that miniaturization of optical fiber array and decrease of dissipation power can be realized.

Further, in the present invention, electromagnetic actuators composed of coils and cores are also capable of being utilized as the above-described actuators.

As described-above, the optical spatial switch of the present invention is a small sized optical spatial switch provided with large capacity capable of transferring spatially a plurality of optical signals of inlet side toward arbitrary optical fibers of light receiving side, as the conventional mechanical telephone switching unit.

In the case where Internet communication is performed, or image containing large communication quantity is communicated, optical spatial switch capable of exchanging a lot of communications has very high utility value in the industry and very high availableness in the industry.

What is claimed is:

1. An optical spatial switch comprising:
a first optical fiber array which outputs optical signals input from optical fibers from output lenses, in which the output lenses convert the input optical signals into converging rays, parallel rays, or diverging rays; and then the output lenses provided with control means output the resulting optical signals in a predetermined direction; and
a second optical fiber array which is provided with light-receiving lenses for receiving optical signals output from the output lenses at a predetermined position in which the light-receiving lenses converge the optical signals received; and then the light-receiving lenses provided with control means transfer the converged optical signals to optical fibers.

2. An optical spatial switch according to claim 1, wherein at least any one of the output lens and the light-receiving lens is a spherical lens.

3. An optical spatial switch according to claim 2, wherein at least any one of the control means of the output lens and the light-receiving lens is an actuator for controlling rotation of the spherical lens.

4. An optical spatial switch according to claim 1, wherein at least one of the control means of the output lens and the light-receiving lens is an actuator for operating the lens in a direction perpendicular to a direction of output light output from the optical fiber.

5. An optical spatial switch comprising:
a first optical fiber array which is provided with output lenses for outputting optical signals input from optical fibers, in which lenses are arranged next to the optical fibers; the output lenses convert the input optical signals into converging rays, parallel rays, or diverging rays; and then the output lenses provided with control means output the resulting optical signals in a predetermined direction; and
second optical fiber array which is provided with light-receiving lenses for receiving optical signals output from the output lenses at a predetermined position, in which the light-receiving lenses converge the optical signals received; and then the light-receiving lenses provided with control means transfer the converged optical signals to optical fibers.

6. An optical spatial switch according to claim 5, wherein the second optical fiber array further comprises a converging lens at mid-position between the light-receiving lens and the optical fiber.

7. An optical spatial switch according to claim 5, wherein at least any one of the output lens and the light-receiving lens is a spherical lens.

8. An optical spatial switch according to claim 7, wherein at least any one of the control means of the output lens and the light-receiving lens is an actuator for controlling rotation of the spherical lens.

9. An optical spatial switch according to claim 5, wherein at least one of the control means of the output lens and the light-receiving lens is an actuator for operating the lens in a direction perpendicular to a direction of output light output from the optical fiber.

10. An optical spatial switch according to claim. 1, further comprising:
a reflecting means which is provided with control means, arranged spatially at mid-position between, the first optical fiber array and the second optical fiber array, and which reflects optical signals output from the output lenses of the first optical fiber array toward the light-receiving lenses of the second optical fiber array.

11. An optical spatial switch according to claim 10, wherein at least any one of the output lens and the light-receiving lens is a spherical lens.

12. An optical spatial switch according to claim 10, wherein the reflecting means is composed of a first reflecting means and a second reflecting means.

13. An optical spatial switch according to claim 10, wherein the first reflecting means and the second reflecting means are mirror reflecting means provided with mirrors controlled by actuators.

14. An optical spatial switch according to claim 10, further comprising:
a mechanism which is composed of a substrate capable of rotating about one axis, a rotating base plate capable of rotating on the substrate about an axis perpendicular to the axis of rotation of the substrate, and a mirror provided on the rotating base plate.

15. An optical spatial switch according to claim 10, further comprising:
a mechanism which is composed of a rotatable first substrate, a rotatable second substrate capable of rotating on the first substrate, and a mirror provided on the second substrate.

16. An optical spatial switch according to claim 10, further comprising:
a mechanism which is composed of a piezoelectric transducer capable of exciting oscillating waves in the two different directions, a movable body that comes into contacts with the piezoelectric transducer, and a mirror provided on the movable body.

17. An optical spatial switch according to claim 10, further comprising:
a mechanism which is composed of a mirror portion made of at least magnetic material, and a plurality of electromagnets provided at positions that overlap onto the mirror portion in its thickness direction.

18. An optical spatial switch comprising:
a first optical fiber array that includes an optical fiber one point of which is supported, a lens fixed on the optical fiber in the vicinity of one end thereof, and a control means that operates the optical fiber in the direction perpendicular to optical axis of the optical fiber; and
a second optical fiber array that includes an optical fiber one point of which is supported to receive optical signals output from the first optical fiber array at a predetermined position, a lens fixed on the optical fiber in the vicinity of one end thereof, and a control means that operates the optical fiber in the direction perpendicular to optical axis of the optical fiber.

19. An optical spatial switch comprising:
a substrate having an opening portion;
a fiber one point of which is supported, that is fitted in the opening portion; and
a lens fixed on the fiber in the vicinity of one end thereof,
wherein the substrate is driven in the two axes directions of X and Y so that angle of output light from the fiber or light-receiving angle of light made incident upon the fiber is varied.

20. An optical spatial switch comprising:
two substrates having opening portions;
a fiber one point of which is supported, that is fitted in the opening portion; and
a lens fixed on the fiber in the vicinity of one end thereof,
wherein the two substrates are driven individually in the two axes directions of X and Y so that angle of output light from the fiber or light-receiving angle of light made incident upon the fiber is varied.

21. An optical spatial switch comprising:
an optical fiber one point of which is supported;
a magnetic member fixed on the optical fiber in the vicinity of one end thereof;
a plurality of yokes provided at outer side of the magnetic member; and
coils wound around the plurality of yokes,
wherein quantity of current flowing through the respective coils is controlled so that angle of the optical fiber is controlled, and then since the angle of the optical fiber is controlled, angle of output light from the optical fiber or light-receiving angle of light made incident upon the optical fiber is varied.

22. An optical spatial switch according to claim 1, wherein the output lenses of the optical fiber array and the light-receiving lenses of the second optical fiber array are arranged in two-dimensional matrix of “integer number I×integer number J,” respectively.

23. An optical spatial switch according to claim 22, wherein I and J of the “integer number I×integer number J” are of integer numbers selected individually from 3 to 9.

24. An optical spatial switch according to claim 1, wherein a plurality of output lenses of the first optical fiber array are arranged in two-dimensional matrix of “integer number I×integer number J”, and a plurality of light-receiving lenses of the second optical fiber array are arranged in two-dimensional matrix of “integer number P×integer number ,Q”, where relationship of respective arrangements satisfies “I×J≦P×Q”.

25. An optical spatial switch according to claim 1, wherein a leading edge portion of an optical fiber, which is connected to the first optical fiber array and the second optical fiber array, is a spherical lens integrated with the optical fiber.

26. An optical spatial switch according to claim 1, wherein leading edge portions of the first optical fiber array and the second optical fiber array are of multi-mode fibers that are connected to single-mode fibers.

27. An optical spatial switch according to claim 1, wherein leading edge portions of the first optical fiber array and the second optical fiber array have configurations in which a single-mode fiber is processed into conical shape, spherical shape, or cylindrical shape which is a combination of the conical shape and the spherical shape.

28. An optical spatial switch according to claim 1, wherein the actuator is a piezoelectric actuator.

29. An optical spatial switch according to claim 1, wherein the actuator is an electromagnetic actuator.

30. An optical spatial switch according to claim 1, wherein the actuator is a ultrasonic actuator that includes a piezoelectric element, a stator with an opening portion, a pressure plate, and a movable body that is sandwiched between the opening portion of the stator and the pressure plate.
